(19) United States
(12) Patent Application Publication
(10) Pub. No.: US 2014/0072309 A9
(43) Pub. Date: Mar. 13, 2014

(54) INFRA-RED REPEATER IN POWER CENTERS

(71) Applicants: Anthony DiChiro, Chatsworth, CA (US); Demian Martin, San Leandro, CA (US)

(72) Inventors: Anthony DiChiro, Chatsworth, CA (US); Demian Martin, San Leandro, CA (US)

(73) Assignee: Monster Cable Products, Inc., Brisbane, CA (US)

(21) Appl. No.: 12/201,691

(22) Filed: Aug. 29, 2008

Related U.S. Application Data
(63) Continuation-in-part of application No. 11/969,870, filed on Jan. 4, 2008.
Application No. 11/969,870 is a continuation-in-part of application No. PCT/US06/62761, filed on Dec. 29, 2006.
(60) Provisional application No. 60/969,853, filed on Sep. 4, 2007.
(60) Provisional application No. 60/755,563, filed on Dec. 29, 2005.

(51) Int. Cl. H04B 10/00

(52) U.S. Cl. 398/106

(57) ABSTRACT

A combined electrical power conditioner and IR controller that provides a single point for communications with a Remote and connects with the various components of a video or audio system which is configured to respond to IR signals. The apparatus receives and routes IR signals either serially or in parallel to the system components through IR capable cables. The apparatus may be equipped with an RF to IR converter for an RF capable remote controller.

### RELATED APPLICATIONS

This application claims priority to provisional patent application 60/969,853, filed Sep. 4, 2007.

### TECHNICAL FIELD

The present invention relates to remote control devices for electronic devices. More particularly, the present invention relates to infra-red (IR) and radio frequency (RF) remote control devices for consumer electrical devices. Still more particularly, the present invention relates to remote control devices using IR and/or RF communication with remotely controllable consumer electronic devices which are connected with electrical power conditioning devices.

### BACKGROUND ART

It is common in the field of consumer electronics to provide IR and RF communication links between an electronic device and a remote controller (Remote) for controlling the device: applying power, removing power, adjusting parameters, etc. To accomplish this, each electronic device is assigned a unique code, either by the manufacturer or consumer, or automatically by the device, so that the device will respond only to a similarly configured Remote. Such items as televisions, music systems, lighting systems, air conditioning/heating (HVAC) systems, camera systems, power control systems, door latches, motion detectors and other similar devices, are frequently configured to respond to a Remote or a remote control device like, but not limited to, a cell phone. IR signals are direct, line of sight communication links, requiring a transmitter to have an unimpeded pathway to a receiver; with RF signals a direct line of sight is not required.

It is further common to insert a power conditioning or protective device between a source of electrical power and an electronic device in order to protect sensitive electronic components from anomalous power parameters. The power conditioning device is frequently located behind or within the cabinetry of the system to enhance the system's appearance.

When a user assembles an electronic system such as a home theater, flat screen television, stereo music system, computerized network, and the like, it is not unusual to combine several electronic devices into the system, each device having its own unique IR or RF code. This results in the user facing the requirement to have either multiple Remotes or a single Remote with multiple code functions. As users become more inventive in assembling systems, the number of electronic devices combined into the system may increase, complicating both the interconnectivity between the components and the design of remote controls. Each device further requires a connection to an electrical power source, frequently through the power conditioning device. This further adds to the number of components and complexity of the system.

As the number of components increases, the connections between the components becomes more complicated. Further, miniaturization of the electronic devices leads to multifunction devices requiring a variety of connectors to properly integrate the system. Should one or more connections be improperly made, the system may suffer damage and will most certainly not function as desired. This requires the user to troubleshoot the system, an activity that may be quite time consuming and can lead to further damage to one or more components. What is needed is a method and apparatus to minimize or eliminate interconnectivity errors and enhance a system's operation.

### DISCLOSURE OF THE INVENTION

Accordingly, the present invention is a combined electrical power conditioner and IR or RF controller that provides a single point for communications with a Remote and reliably connects with the various components of a video or audio system which are configured to respond to IR signals. The apparatus provides a connection with an alternating current (AC) power source, receives and routes IR signals, and connects either serially or in parallel with the system components through IR capable cables (i.e., optical cables coupled with an IR receiver and/or transmitter as indicated in FIGS. 3-9D). The apparatus is preferably configured to be installed within a cabinet or otherwise out of sight within the room. Alternatively, the apparatus may be configured within a suitable containment to be a visible component of a system, much like a set-top device commonly used with televisions. In the case of an RF Remote, the apparatus is equipped with an RF to IR conversion device which enhances the use by eliminating the line of sight restriction of IR links.

The electrical power conditioner portion of the apparatus provides protection for the electronic components of the system. Anomalous AC power conditions such as over or under voltage, over or under current, phase or frequency shifting, noise, radio frequency interference, etc. are detected and mitigated before electrical power is provided to the other components of the user's system.

The IR controller portion of the apparatus includes a microprocessor and provides a receiver for receiving IR commands from a Remote and a transmitter for retransmitting the commands on to individual components of the user's system. The controller may retransmit IR commands either serially or in parallel, depending on the user's preference and/or individual component capabilities. In the preferred embodiment, the IR controller is placed within a cabinet behind a door or other covering, and connected via an IR capable cable with an IR sensor in such a way to provide a line of sight pathway for communications with a Remote. Alternatively, the apparatus may be provided as a visible component of a user's system, and the IR sensor incorporated into the IR controller, the combination enclosed within a suitable housing. The IR controller can be equipped with an IR remote receiver only or RF to IR, and may be equipped with both IR and RF as the controlling instrument.

The RF controller portion of the apparatus, if so configured, cooperates with an RF sensor to receive RF commands from a Remote, then translates the RF commands into IR for retransmission over an IR capable cable to the appropriate device. The controller may retransmit IR commands either serially or in parallel, depending on the user's preference and/or individual component capabilities.

In summary, the present invention uniquely provides the capability for:

a) Set up of control sets and control devices attached to the power conditioner;
b) Set up of control sets for devices within the system;
c) Networking of a portable computer or the handheld remote set up of devices in the system;
d) Transcoding RF to IR device specific codes sets;
e) Use of generic remotes with generic control code sets;
f) Transcoding generic code sets to device specific control code sets; and
g) Wideband IR repeating capability.
Thus allowing a user to use the Remote that comes with an electronic device when the device is in a cabinet, without the need to use the special remote that is part of the smart system.

### BRIEF DESCRIPTION OF THE DRAWING

For a better understanding of the present invention, reference is made to the below referenced accompanying Drawing. Reference numbers refer to the same or equivalent parts of the present invention throughout the several figures of the Drawing.

FIG. 1 is a diagrammatic illustration of the system of the present invention.

FIG. 2 is an illustration of an exemplary connector panel of the present invention.

FIG. 3 is an exemplary block diagram of a portion of the present invention.

FIG. 4 is an exemplary block diagram of an enhanced power center of the present invention.

FIG. 5 is an exemplary block diagram of a portion of the power center of the present invention.

FIG. 6 is a block diagram illustrating exemplary elements of the repeater portion of the present invention.

FIG. 7 is an exemplary schematic diagram of the present invention IR receiver.

FIGS. 8A-8B are details of an exemplary schematic diagram of the present invention IR repeater.

FIGS. 9A-9D are details of an exemplary schematic diagram of the present invention IR internal receiver.

### MODES FOR CARRYING OUT THE INVENTION

The present invention is a combined power conditioning unit and IR or RF controller (IR repeater 110) that provides a single point for line of sight communications with an IR Remote 105 and reliably connects with the various electronic devices (120, 121, 122) of a video or audio system which are configured to respond to IR signals. The apparatus provides a connection with a power source, receives and routes IR signals, and connects with the system components through IR capable cables. The IR repeater 110 cooperates with an IR sensor 112 for receiving IR commands from a Remote 105 and retransmits the commands on to individual components of the user's system. IR repeater 110 may retransmit IR commands either serially or in parallel, depending on the user's preference and/or individual component capabilities. In the preferred embodiment, the IR Repeater 110 is connected via an IR capable cable with an IR sensor 112 which is mounted on the user's system, such as in a cabinet, in such a way to provide IR sensor 112 a line of sight pathway for communications with Remote 105. Alternatively, IR sensor 112 may be provided as a component of a user's system, in which case the IR sensor 112 is mounted with or in IR repeater 110 which is placed in a position to provide a line of sight pathway with remote 105.

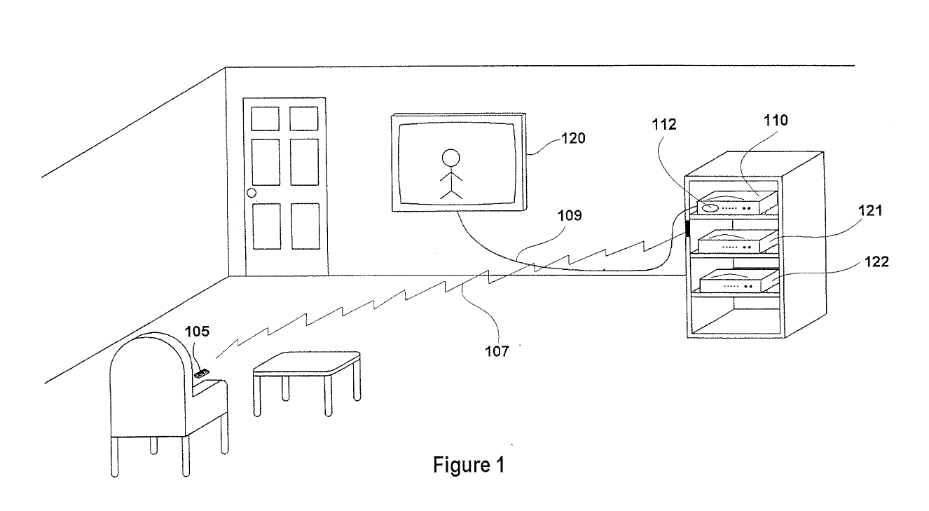

Referring now to FIG. 1, the exemplary components of the present invention are illustrated. IR repeater 110 may be housed in a single case, suitable for open display within a user's room; the case further containing IR sensor 112. Alternatively, IR repeater 110 may be physically separated from IR sensor 112 and connected therewith via an IR capable cable (not shown). Remote 105 is used by an operator to send control commands over IR link 107 to IR sensor 112. In the case of an RF Remote 105, IR link 107 would be an RF link and IR repeater 110 would be equipped with an RF to IR conversion capability which enhances the system flexibility by eliminating the IR line of sight restriction between IR Remote 105 and sensor 112. An RF configured apparatus may be enclosed in a cabinet, leaving no visible components.

IR repeater 110 receives control commands from IR sensor 112 and retransmits the command over IR capable cables to the desired electronic device 120, 121, or 122. Electronic devices 120, 121, 122 may be any number of electronic devices such as audio or visual devices, computational devices, and the like. For example, first device 120, represented here for illustration only and not intended to be limiting, may be a television and is connected with IR repeater 110 via IR capable cable 109.

IR repeater 110 preferably contains alternating current (AC) power conditioning components (not shown) suitable for the power consumption load of all connected electronic devices. The power conditioning portion of the apparatus provides protection for the electronic components of the system. The power conditioning components ameliorate or eliminate anomalous or unwanted power conditions such as over or under voltage, over current, phase shifts, frequency shifts, radio frequency interference, power spikes, noise filtering, etc. IR repeater 110 is provided with a plurality of power outlets to receive the power cords of individual system components. Anomalous power conditions are detected and mitigated before electrical power is provided to the other components of the user's system.

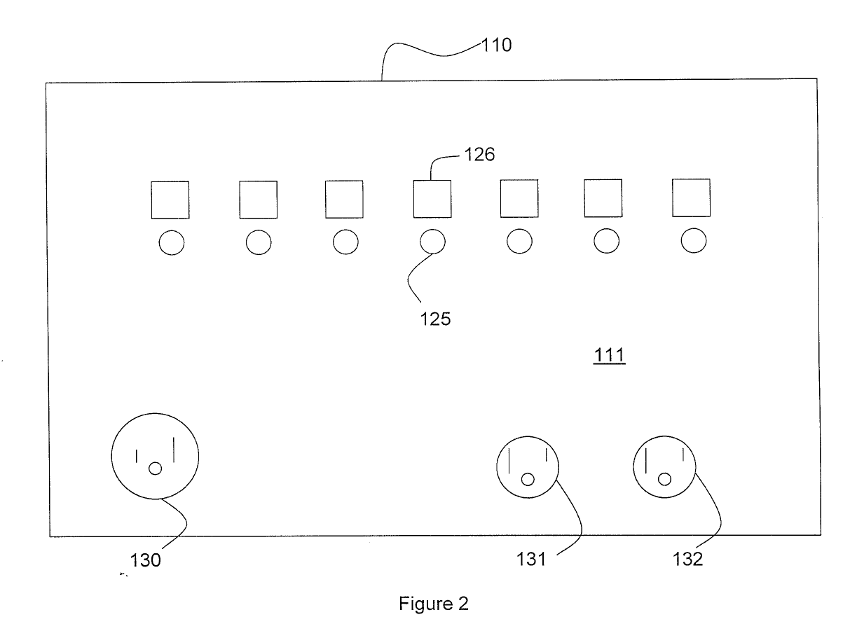

Referring now to FIG. 2, an illustration of an exemplary connector panel 111 of the IR Repeater 110 is shown. Connector panel 111 is preferably located on the back of IR repeater 110, but may alternatively be located on a side, top or the front if desired. Power connection 130 is preferably a plug for receiving a standard alternating current (AC) power cord for powering IR repeater 110, but alternatively may be a hard wired conventional power cord. Power outlets 131, 132, represent one or more outlets that receive conditioned power from the power conditioning portion of IR Repeater 110 and are used to provide conditioned power to the electronic devices 120, 121, 122, etc.

Connector socket 125 represents a plurality of sockets, one each for each electronic device to be controlled by IR repeater 110 and one for IR sensor 112. Each connector socket 125 is specific for each component and is identified by identifier 126. Identifier 126 may be a label containing markings such as text, numerals, colors and/or symbols to identify the type of device associated with that connector socket to facilitate assembly of the system. Each connector socket 125 is configured to accept a standard connector plug for an IR capable cable 109 to connect electronic devices with IR Repeater 110

Cable 109 may be either unmarked or preferably be uniquely marked or labeled with text, numerals, colors and/or symbols to identify the type of device for which it is intended. Alternatively, each of connector sockets 125 may be physically uniquely formed to be connectable only with a cable which is similarly physically formed. IR capable cables 109 are preferably single conductors but may be bundled into multiconductor cables for convenience in some applications.

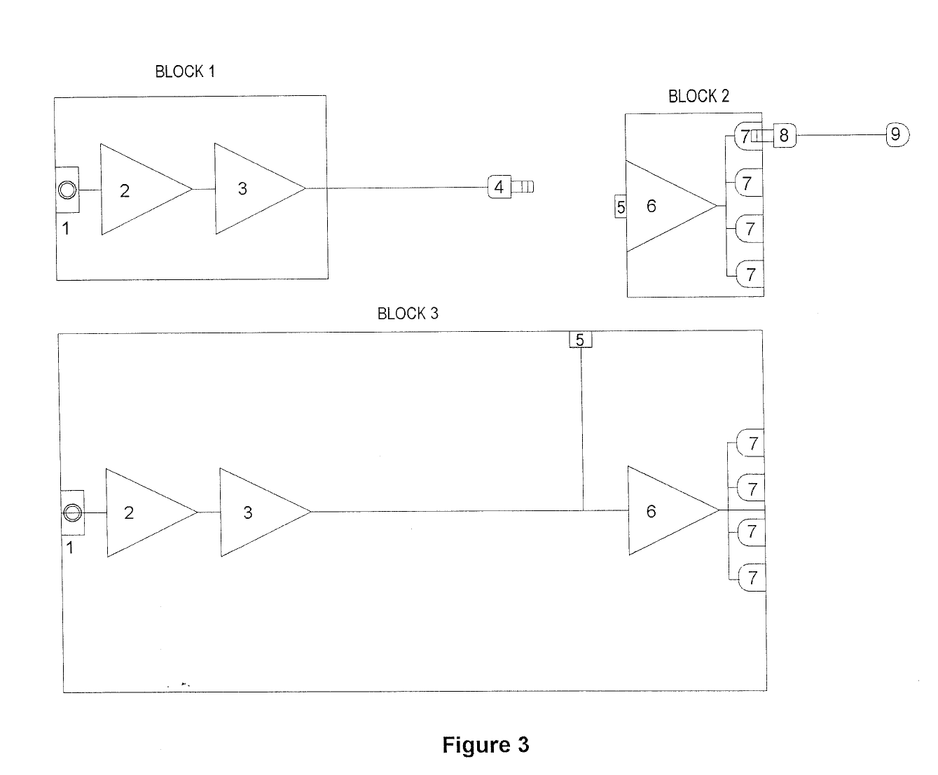

Referring now to FIGS. 3 through 6, block diagrams indicate the functionality of the IR-RF device controller built into the power center. In FIG. 3, blocks 1 and 2 represent the embodiment wherein the IR sensor is separated from the IR repeater. Block 1 indicates the remote receiver required for the power center in a cabinet behind closed doors. The IR sensor 112 is located in line of sight of the control device and plugged into the power center to allow for IR repeating. Item 1 is a wideband IR diode which allows for signals of multiple frequencies to be. received. Item 2 is a wideband amplifier required to amplify this IR signal that is received from the diode. Item 3 is a current amplifier to increase the current necessary to drive the output circuit. Item 4 is a connector and cable to allow the receiver to be put in a remote location.

Also in FIG. 3, Block 2 is internal to the power center. Item 5 is the connector that allows for the remote receiver to be plugged into a current gain stage built into the power center. Item 6 is the high current amplifier that provides the power to the remote IR emitters. This high current gain stage can handle a multiple of IR emitter outputs. Item 7 is the IR emitter outputs, this connector allows for external IR emitters to be plugged into item 8 and 9 IR emitter assembly. These are attached or pointed at the devices that require IR control. Further in FIG. 3, Block 3 has all the same elements as Block 1; the difference is this is a combined implementation instead of a remote implementation.

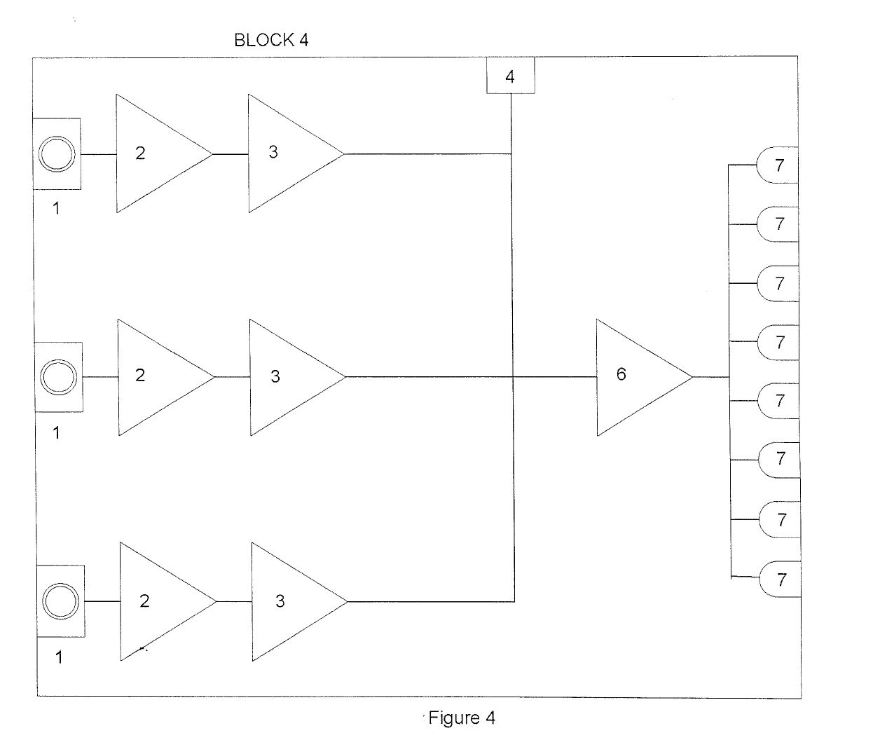

The preferred embodiment of the present invention is represented by FIGS. 4-9. As shown in FIG. 4, Block 4 has all the same elements as Block 3. The difference is that it has three IR input diodes 1. The multiple input diodes increase the sensitivity, range and angle at which the IR signal can be received.

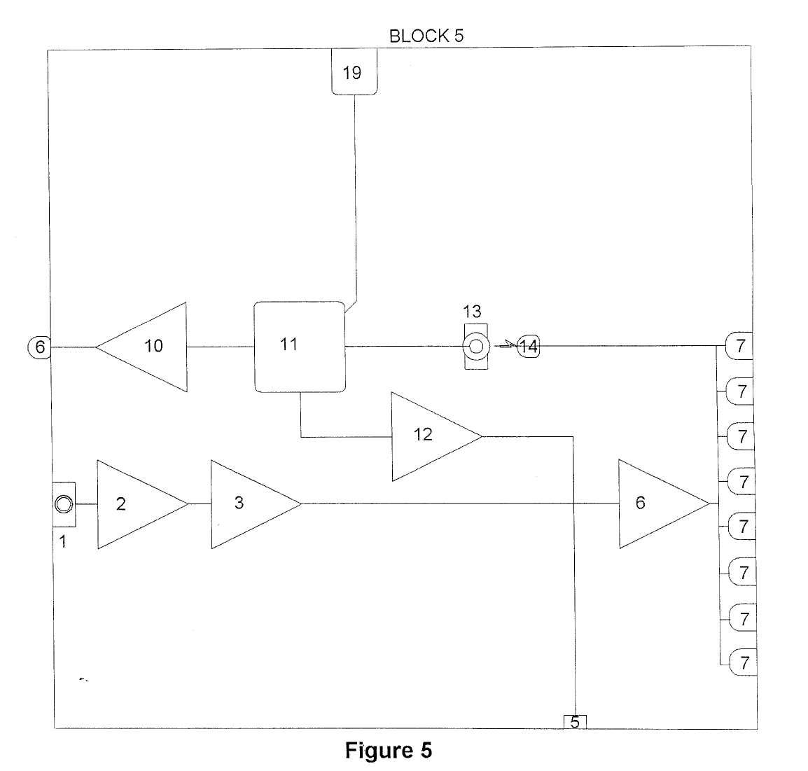

Referring to FIG. 5, Block 5 is a more advanced implementation built into the power center. There are five additional elements that are required for this advanced implementation. This advanced implementation requires a suitably programmed micro controller to allow control of elements within the power center, like turning the power receptacles on and off. There are complex control issues that also require the micro processor, like receiving and emitting IR in the same plane. Items one through seven remain the same as in the earlier block diagrams. Item 14 is a wideband IR emitter 14. The IR codes are received by code receiver 13. This IR receiver can be tuned to be a wideband receiver or narrowband receiver or any combination in between. This allows for very accurate tuning for control devices that are used to control systems and devices attached to the power center. This also provides complete electrical isolation between the IR receiving devices and the micro controller system.

Micro processor 11 takes in information from items 19 and 13, and outputs information to items 10 and 12. The micro processor item 11 passes information back and forth to item 19, which is the control path of the power center. This is a two-way communication between the microprocessor 11 and various functions within the power center. Some of these functions are, but not limited to, current sensing of the output receptacles, turning on and off the output receptacles, pass information along the control chain, both IR and other methods to control devices within the system, and allowing control devices and control systems to know the status of devices connected to the power center. Item 10 provides current to drive IR emitters 7. Microprocessor 11 allows the power center to receive IR and transmit IR on the same plane without interference by knowing the presence of input IR signals by Item 14 and Item 13. This communication is very reliable and allows for interoperability because this information is coupled between Item 13, 14 and 11 optically. There is no electrical connection between Item 13 and Item 14.

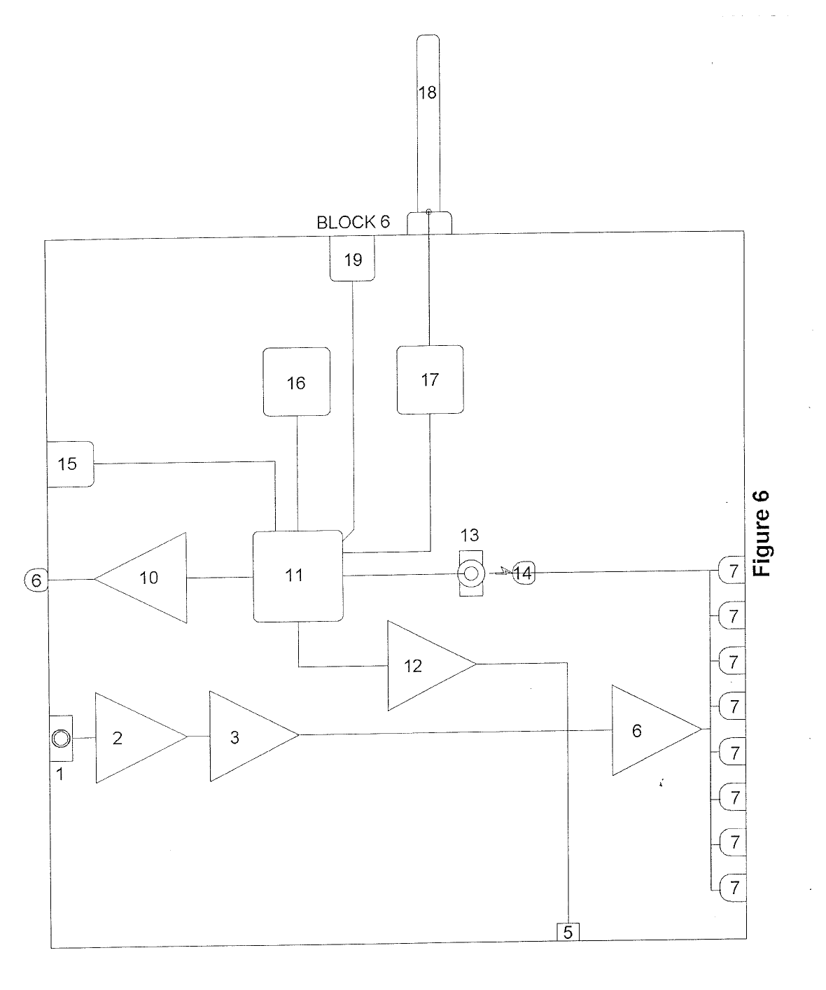

As shown in FIG. 6, Block 6 has 5 additional elements to allow the power center to be able to repeat IR signals, repeat RF signals, and communicate with a network or network devices, and with the internal database. Item 15 is added to the system to allow microprocessor 11 to communicate with a stand-alone network and/or the Web. This allows for complete remote control of the power center and the entire device connected to it from a remote location. This remote location can be anywhere that there is access to the Web. This communication is not limited to just control, there is real-time status communicated to this remote location. An example of this is a lighted light that is plugged into the power center. A user can turn this light off or on from that remote location. This is just one example of many similar activities that can be controlled both locally and from a remote location. Item 16 is a database of metadata, IR codes for most consumer electronic devices, and RF reference codes for consumer electronic and lighting devices for a home environment like, but not limited to, thermostats. These codes are used to control devices plugged into the power center and RF devices that are part of the connected home environment. This database is updated from the network connection Item 15. Item 17 is a RF receiver or a WiFi receiver, but is not limited to these technologies. Item 18 is the antenna. The combination of items 15, 16, 17 and 18 provide advance functionality, one of these advanced functions, but not limited thereto, is devices can be controlled with a remote control device that outputs generic IR or RF signals that are received by either Item 1 or Item 5 the IR input or Item 18 RF input which are then trans coded in the microprocessor Item 11 and the database 16 to device specific IR codes to control those device in the system.

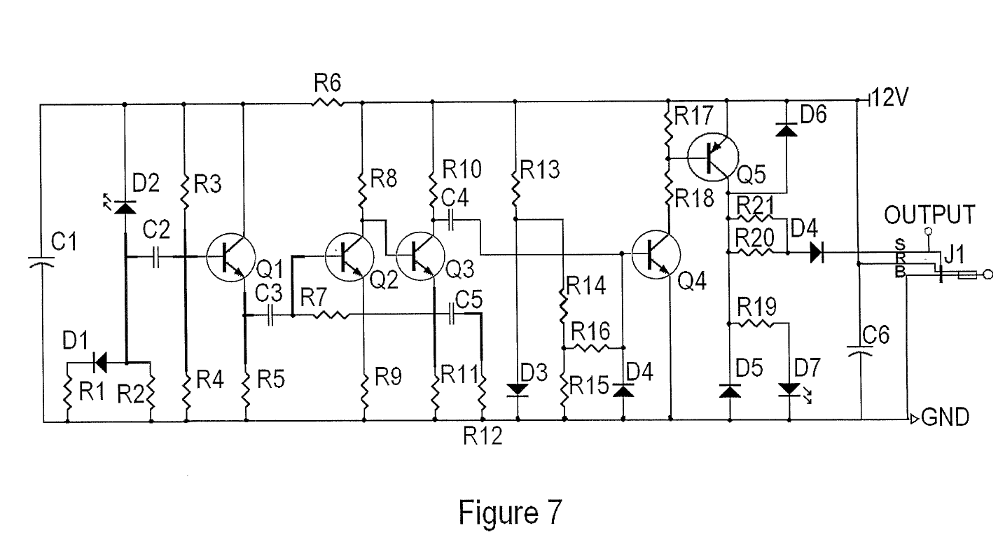

FIGS. 7 through 9D are schematics of the preferred embodiment of the present invention. Heavier lines in the schematics indicate critical paths that should be kept physically to the shortest practical length. The present invention, with appropriately programmed microprocessor 11, provides the capability for: setting up control sets and control devices attached to the power conditioner; setting up control sets for devices within the system; networking of portable computer or the handheld remote set up of devices in the system; transcoding RF to IR device specific codes sets; using generic remotes with generic control code sets; transcoding generic code sets to device specific control code sets; and wideband IR repeating capability. Thus, allowing a user to use the Remote that comes with an electronic device when the device is in a cabinet, without the need to used the special remote that is part of the smart system. Tables 1 through 3 provide exemplary parts lists for the schematics of FIGS. 7 through 9D.

TABLE 1
Wide Band IR Receiver (FIG. 7)

| PART TYPE | DESIGNATOR |
|---|---|
| 1K | R18 |
| 2K | R10 |
| 4.7K | R19 |
| 5.6K | R14 |
| 8.2K | R13 |
| 10K | R1, R5, R8, R15, R17 |
| 15 | R12 |
| 33 | R9 |
| 56K | R7, R16 |
| 100 uF/16 | C1, C6 |
| 200 | R6, R11, R20-R21 |
| 200K | R2 |
| 330 pF | C2 |
| 470 nF | C4-C5 |
| 470 pF | C3 |
| 510K | R3-R4 |
| BAS 16 | D1, D3-D6 |
| Green | D7 |
| MMBT3904 | Q1-Q4 |
| MMBT3906 | Q5 |
| PCB | PCB1 |
| Phone plug 4 | J1 |
| SFH205F | D2 |
| Shield can | Can 1 |

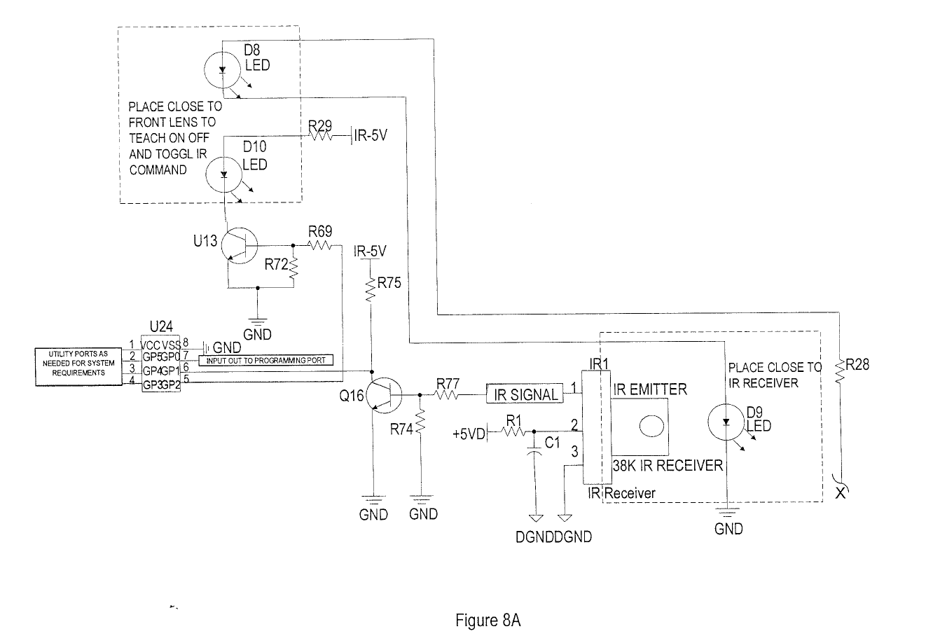

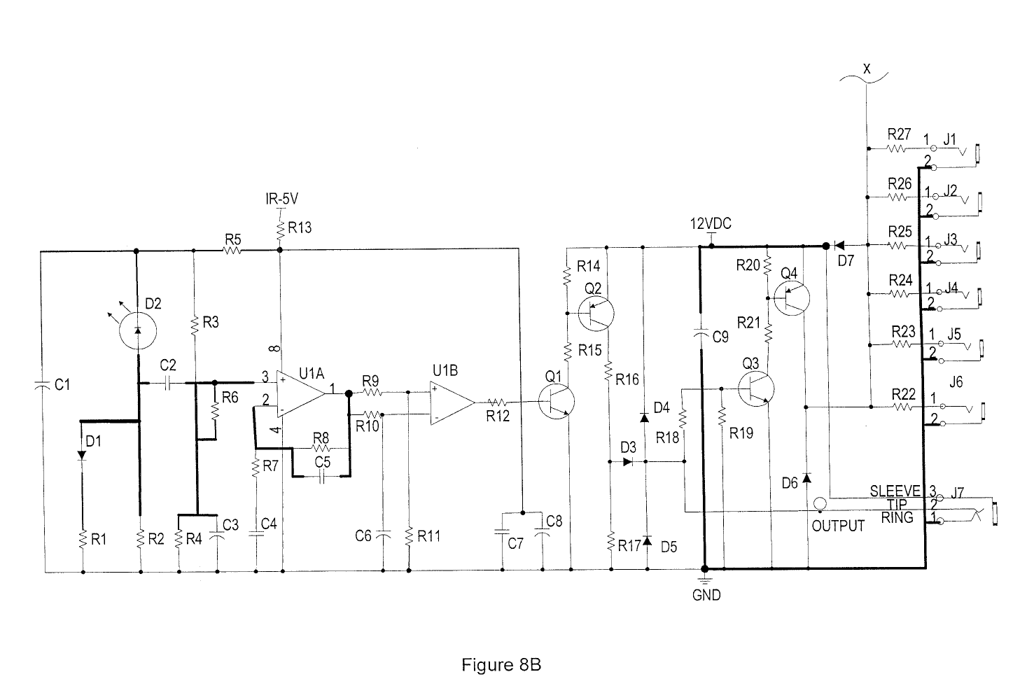

TABLE 2
IR Opto Repeater (FIGS. 8A-8B)

| PART TYPE | DESIGNATOR |
|---|---|
| 1.2K | R9 |
| 1K | R14, R21 |
| 1N914 | D1 |
| 1 uF | C6 |
| 2.2K | R28 |
| 2SA1020 | Q4 |
| 4.7K | R12, R69, R77 |
| 5.1K | R15, R18 |
| 10K | R8, R10, R17, R20, R75 |
| 10 uF/16 | C1 |
| 12K | R1, R3-R4 |
| 20K | R72, R74 |
| 47 | R13 |
| 47 uF | C3 |
| 100 nF | C4, C7 |
| 100 pF | C2 |
| 100 uF | C8 |
| 100 uF/16 | C9 |
| 150 | R7 |
| 220 | R16 |
| 220K | R2, R6, R11 |
| 220 pF | C5 |
| 270 | R5 |
| 470 | R22-R27, R29 |
| 510 | R19 |
| BAS16 | D3-D7 |
| IR receiver | IR 1 |
| LED | D9-D10 |
| LED Green | D8 |
| Minijack | J1-J6 |
| MMB3904 | U13 |
| MMBT3904 | Q1, Q3, Q16 |
| MMBT3906 | Q2 |
| OPA2822 | U1 |
| Phone jack 2 | J7 |
| PIC12F683 | U24 |
| SHF253 | D2 |

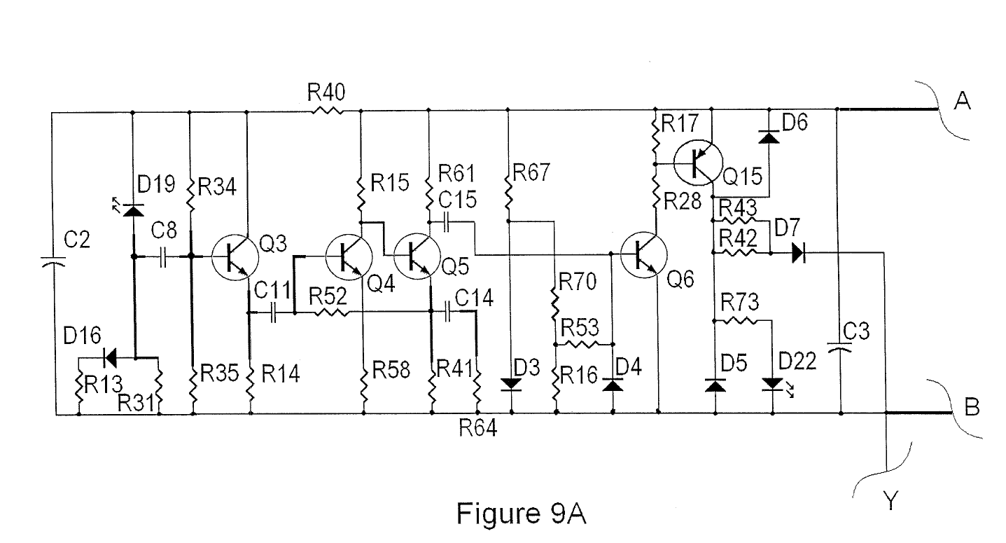

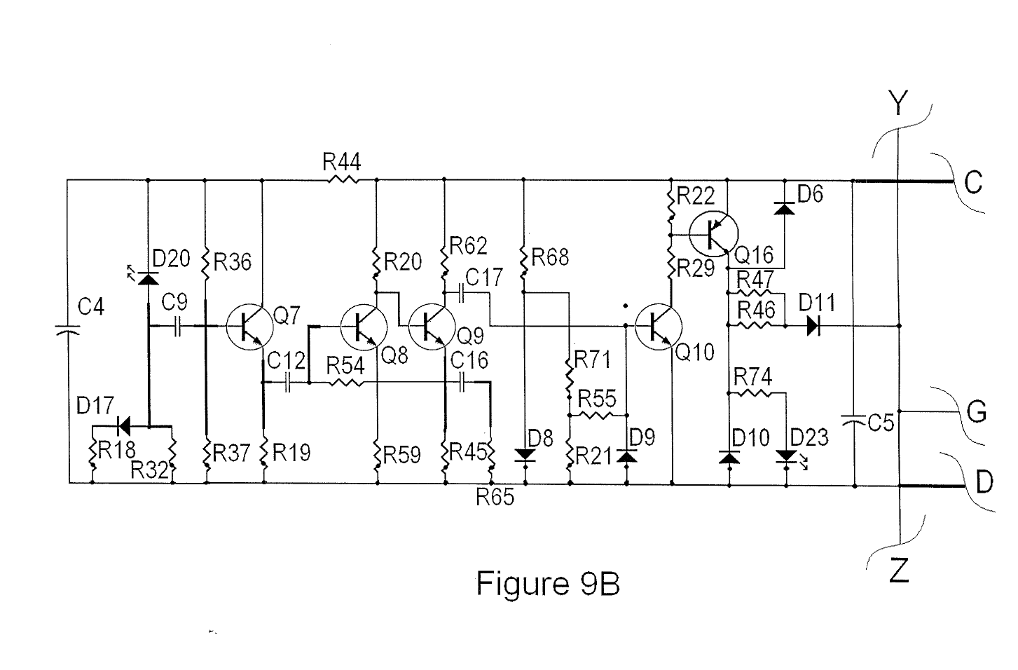

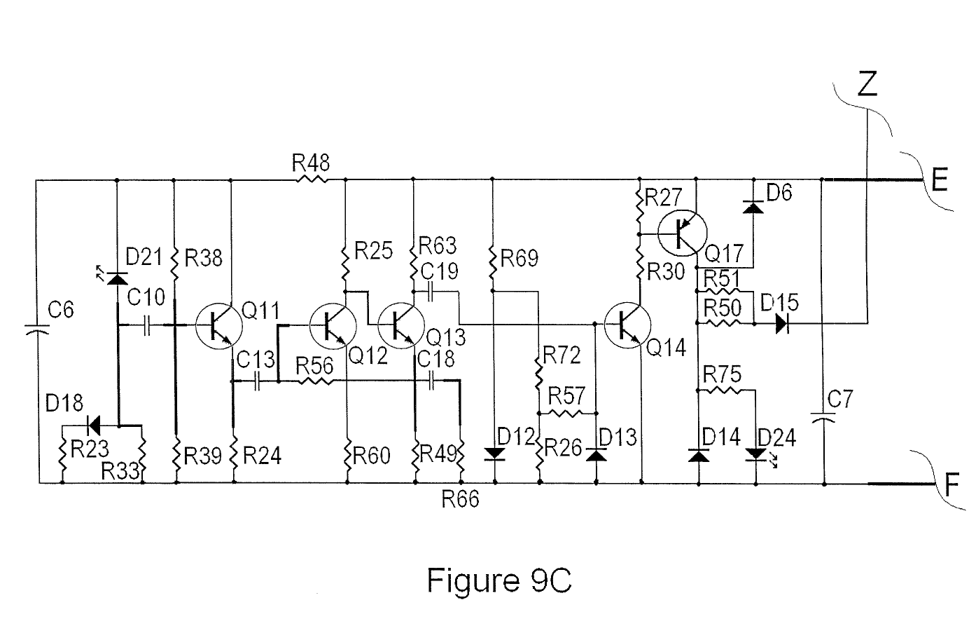

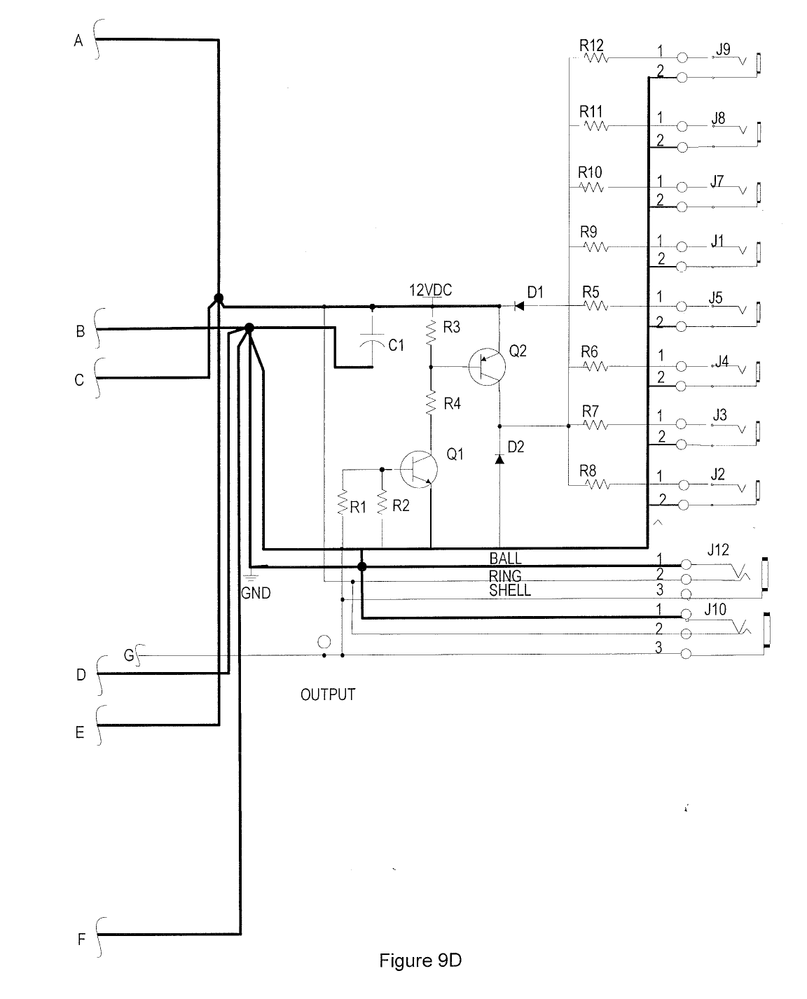

TABLE 3
IR Combo (FIGS. 9A-9D)

| PART TYPE | DESIGNATOR |
|---|---|
| 1K | R4, R28-R30 |
| 2K | R61-R63 |
| 2SA1020 | Q2 |
| 4.7K | R73-R75 |
| 5.1K | R1 |
| 5.6K | R70-R72 |
| 8.2K | R67-R69 |
| 10K | R3, R13-R27 |
| 15 | R64-R66 |
| 33 | R58-R60 |
| 56K | R52-R57 |
| 100 uF/16 | C1-C7 |
| 200 | R40-R51 |
| 200K | R31-R33 |
| 330 pF | C8-C10 |
| 470 | R5-R12 |
| 470 nF | C14-C19 |
| 470 pF | C11-C13 |
| 510 | R2 |
| 510K | R34-R39 |
| BAS 16 | D1, D3-D15 |
| BAS | D16-D18 |
| Diode | D2 |
| Green | D22-D24 |
| Minijack, Mono, 3.5 mm | J1-J5, J7-J9 |
| Minijack, Stereo, 3.5 mm | J10, J12 |
| MMBT3904 | Q3-Q14 |
| MMBT3906 | Q15-Q17 |
| NPN | Q1 |
| PCB | PCB1 |
| SFH205F | D19-D21 |
| Shield Can | Can 1-Can 3 |

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.”

All structural and functional equivalents to the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. 112, sixth paragraph, unless the element is expressly recited using the phrase “means for.”

### INDUSTRIAL APPLICABILITY

The present invention applies industrially to electronic device control networks. More particularly, the present invention applies to remotely controlled electronic device control networks. The present invention may be assembled by a knowledgeable practitioner using readily available components.

What is claimed:

1. A remote control apparatus for an electronic system having remotely controllable electronic devices, comprising:
an electrical power conditioner for receiving AC power from a source and providing conditioned power to a plurality of outlets connectable with the electronic devices;
a remote control for generating commands;
a sensor for receiving commands from the remote;
a repeater for receiving commands from the sensor and retransmitting the commands over IR capable cables; and
IR capable cables for connecting the repeater with the electronic devices.

2. The apparatus of claim 1 wherein the electrical power conditioner comprises circuitry for protecting the electronic components from one or more anomalous AC electrical power conditions selected from the group of conditions consisting of over voltage, under voltage, over current, under current, power spikes, noise, radio frequency interference, phase shifts, and frequency shifts.

3. The apparatus of claim 1 wherein the repeater incorporates a microprocessor programmed to perform one or more functions selected from the group of functions consisting of setting up control sets and control devices attached to the power conditioner; setting up control sets for devices within the system; networking of portable computer or the handheld remote set up of devices in the system; transcoding RF to IR device specific codes sets; using generic remotes with generic control code sets; transcoding generic code sets to device specific control code sets; and wideband IR repeating.

4. The apparatus of claim 1 wherein the repeater has a plurality of sockets for connecting with the IR capable cables, each socket having a unique identifier label.

5. The apparatus of claim 4 wherein the IR capable cables further have at least one unique label having markings selected from the group of markings consisting of text, numerals, colors and symbols.

6. The apparatus of claim 1 wherein the remote control device communicates with the sensor over a link selected from the group of links consisting of an IR link and a RF link.

7. The apparatus of claim 2 wherein the repeater has a plurality of sockets for connecting with the IR capable cables, each socket having a unique identifier label selected from the group of labels consisting of text, numerals, colors and symbols, and the cables have at least one corresponding unique label selected from the group of labels consisting of text, numerals, colors and symbols.

8. The apparatus of claim 7 wherein the remote control device communicates with the sensor over a link selected from the group consisting of an IR link and a RF link.

9. The apparatus of claim 3 wherein the repeater has a plurality of sockets for connecting with the IR capable cables, each socket having a unique identifier label selected from the group of labels consisting of text, numerals, colors and symbols, and the cables have at least one corresponding unique label selected from the group of labels consisting of text, numerals, colors and symbols.

10. The apparatus of claim 9 wherein the remote control device communicates with the sensor over a link selected from the group consisting of an IR link and a RF link.

11. The apparatus of claim 6 wherein the cables further have on both ends unique labels selected from the group of labels consisting of text, numerals, colors and symbols.

12. The apparatus of claim 6 wherein the electrical power conditioner comprises circuitry for protecting the electronic components from one or more anomalous AC electrical power conditions selected from the group of conditions consisting of over voltage, under voltage, over current, under current, power spikes, noise, radio frequency interference, phase shifts, and frequency shifts.

13. A remote control apparatus for an electronic system having remotely controllable electronic devices, comprising:
an electrical power conditioner for receiving AC power from a source and providing it to outlets connectable with the electronic devices, wherein the electrical power conditioner comprises circuitry for protecting the electronic components from one or more anomalous AC electrical power conditions selected from the group consisting of over voltage, under voltage, over current, under current, noise, radio frequency interference, phase shifts, and frequency shifts;
a remote control for generating commands;
a sensor for receiving commands from the remote over a link selected from the group of links consisting of an IR link and an RF link;
a repeater for receiving commands from the sensor and retransmitting the commands over IR capable cables; and
IR capable cables for connecting the repeater with the electronic devices.

14. The apparatus of claim 13 wherein the cables further have at least one unique label selected from the group of labels consisting of text, numerals, colors and symbols.

15. The apparatus of claim 13 wherein the repeater incorporates a microprocessor programmed to perform one or more functions selected from the group of functions consisting of setting up control sets and control devices attached to the power conditioner; setting up control sets for devices within the system; networking of portable computer or the handheld remote set up of devices in the system; transcoding RF to IR device specific codes sets; using generic remotes with generic control code sets; transcoding generic code sets to device specific control code sets; and wideband IR repeating.

16. The apparatus of claim 15 wherein the repeater has a plurality of sockets for connecting with the IR capable cables, each socket having a unique identifier label selected from the group of labels consisting of text, numerals, colors and symbols, and the cables have at least one corresponding unique label selected from the group of labels consisting of text, numerals, colors and symbols.

17. The apparatus of claim 13 wherein the repeater has a plurality of sockets for connecting with the IR capable cables, each socket having a unique identifier label selected from the group of labels consisting of text, numerals, colors and symbols, and the cables have at least one corresponding unique label selected from the group of labels consisting of text, numerals, colors and symbols.

18. A remote control apparatus for an electronic system having remotely controllable electronic devices, comprising:
an electrical power conditioner for receiving AC power from a source and providing it to outlets connectable with the electronic devices, wherein the electrical power conditioner comprises circuitry for protecting the electronic components from one or more anomalous AC electrical power conditions selected from the group of conditions consisting of over voltage, under voltage, over current, under current, noise, radio frequency interference, phase shifts, and frequency shifts;
a remote control for generating commands;
a sensor for receiving commands from the remote over a link selected from the group consisting of an IR link and an RF link;
a repeater for receiving commands from the sensor and retransmitting the commands over IR capable cables, the repeater including a microprocessor programmed to perform one or more functions selected from the group of functions consisting of setting up control sets and control devices attached to the power conditioner; setting up control sets for devices within the system; networking of portable computer or the handheld remote set up of devices in the system; transcoding RF to IR device specific codes sets; using generic remotes with generic control code sets; transcoding generic code sets to device specific control code sets; and wideband IR repeating; and
IR capable cables for connecting the repeater with the electronic devices.

19. The apparatus of claim 18 wherein the repeater has a plurality of sockets for connecting with the IR capable cables, each socket having a unique identifier label selected from the group of labels consisting of text, numerals, colors and symbols, and the cables have at least one corresponding unique label selected from the group of labels consisting of text, numerals, colors and symbols.

20. The apparatus of claim 18 wherein the remote control device communicates with the sensor over a link selected from the group consisting of an IR link and a RF link.
